(19) United States
(12) Patent Application Publication
(10) Pub. No.: US 2016/0146332 A1
(43) Pub. Date: May 26, 2016

(54) DRIVING SYSTEM FOR VEHICLE

(71) Applicant: TOYOTA JIDOSHA KABUSHIKI KAISHA, Toyota-shi (JP)

(72) Inventors: Makoto TANIGUCHI, Toyota-shi (JP); Michitaka TSUCHIDA, Miyoshi-shi (JP); Mitsuki WATANABE, Anjo-shi (JP); Masashi SAKAGUCHI, Osaka (JP)

(73) Assignee: TOYOTA JIDOSHA KABUSHIKI KAISHA, Toyota-shi (JP)

(21) Appl. No.: 14/947,518

(22) Filed: Nov. 20, 2015

(30) Foreign Application Priority Data
Nov. 26, 2014 (JP) 2014-238869

(51) Int. Cl. F16H 57/04; B60K 6/365; F16H 3/54

(52) U.S. Cl. CPC F16H 57/0479; F16H 57/0484; F16H 57/043; F16H 3/54; B60K 6/365; F16H 2200/2005; F16H 2200/2033; Y10S 903/91

(57) ABSTRACT

A driving system includes a first oil receiver and a power split mechanism. The power split mechanism includes an input shaft and a hollow shaft portion. The input shaft has a lubricating oil passage and a first oil hole. The first oil hole communicates the lubricating oil passage with an outer face of the input shaft. The hollow shaft portion is fitted to a radially outer side of the input shaft so as to be relatively rotatable, and has a through portion extending through from an inner face to an outer face of the hollow shaft portion. The first oil receiver is arranged on an outer side of the through portion in a radial direction of the hollow shaft portion, and configured to trap oil spattered outward from the through portion in the radial direction of the hollow shaft portion and guide trapped oil to the pinion gears.

### INCORPORATION BY REFERENCE

The disclosure of Japanese Patent Application No. 2014-238869 filed on Nov. 26, 2014 including the specification, drawings and abstract is incorporated herein by reference in its entirety.

### BACKGROUND OF THE INVENTION

1. Field of the Invention

The invention relates to a system that generates driving force for propelling a vehicle and, more particularly, to a driving system for a vehicle, including a power split mechanism that distributes power, output from an engine, to a motor and an output member.

2. Description of Related Art

An example of a system of this type is described in International Application Publication No. 2011/114785. The system includes a single-pinion planetary gear mechanism. The single-pinion planetary gear mechanism includes a sun gear, a ring gear and a carrier. A first motor generator is coupled to the sun gear. A drive shaft is coupled to the ring gear. An output shaft of an engine is coupled to the carrier via an input shaft. The system is configured to be able to apply the output torque of a second motor generator to the drive shaft. The input shaft has a lubricating oil passage and release holes. Lubricating oil flows through the lubricating oil passage. The release holes communicate with the lubricating oil passage. When the input shaft rotates, lubricating oil spatters from the release holes by centrifugal force. A receiver is attached to an engine-side end face of the carrier. The receiver is open to the inner side in the radial direction. The receiver is configured to, when the input shaft rotates, collect oil, which has been spattered from the release holes, and guide the collected oil to pinion gears. In addition, a liquid storage portion is arranged at the upper side of a casing. The liquid storage portion stores oil dipped by a counter gear, a differential ring gear, or the like. The liquid storage portion has a liquid dripping port for dripping lubricating oil toward the planetary gear mechanism. Another receiver is attached to an end face of the carrier across from the engine. This second receiver is open to the outer side in the radial direction. This second receiver is configured to collect oil, dripped from the liquid dripping port, and guide the collected oil to the pinion gears.

In the configuration described in International Application Publication No. 2011/114785, when the vehicle travels in a state where the input shaft does not rotate, oil dipped by the counter gear, differential ring gear, or the like, to the liquid storage portion is dripped from the liquid storage portion. The dripped oil is collected by the second receiver, and is supplied to the pinion gears. Therefore, depending on a traveling state of the vehicle, there is a possibility that the amount of oil supplied to the pinion gears becomes insufficient and, as a result, lubrication of the pinion gears becomes insufficient.

### SUMMARY OF THE INVENTION

The invention provides a driving system for a vehicle, which is able to lubricate pinion gears even when a vehicle travels in a state where an input shaft does not rotate.

The driving system related to the present invention includes an engine, a motor, an output member, a power split mechanism and a first oil receiver. The power split mechanism is configured to distribute power, output from the engine, to the motor and the output member. The power split mechanism includes a sun gear, a ring gear, a carrier, an input shaft and a hollow shaft portion. The sun gear is an external gear. The ring gear is an internal gear, and arranged concentrically with the sun gear. The motor is coupled to one of the sun gear and the ring gear. The output member is coupled to the other one of the sun gear and the ring gear. The carrier supports a plurality of pinion gears so as to be rotatable and revolvable. The plurality of pinion gears is in mesh with the sun gear and the ring gear. The input shaft couples the carrier to the engine. The input shaft has a lubricating oil passage and a first oil hole. The first oil hole communicates the lubricating oil passage with an outer face of the input shaft. The hollow shaft portion rotates integrally with the sun gear and the hollow shaft portion is fitted to a radially outer side of the input shaft so as to be relatively rotatable. The hollow shaft portion has a through portion. The through portion extends through from an inner face of the hollow shaft portion to an outer face of the hollow shaft portion. The first oil receiver is arranged on an outer side of the through portion in a radial direction of the hollow shaft portion. The first oil receiver is configured to trap oil spattered outward from the through portion in the radial direction of the hollow shaft portion and guide trapped oil to the pinion gears.

With this driving system, the engine is coupled to the carrier of the power split mechanism, the motor is coupled to one of the sun gear and the ring gear in the power split mechanism, and the output member is coupled to the other one of the sun gear and the ring gear. That is, when the vehicle travels in a state where the engine is stopped, the sun gear rotates. The hollow shaft portion having the through portion is integrally provided with the sun gear. Those sun gear and hollow shaft portion are fitted to the outer side of the input shaft of the power split mechanism so as to be relatively rotatable. The input shaft has the lubricating oil passage and the oil hole that communicates with the lubricating oil passage. Therefore, oil supplied to the lubricating oil passage passes through the oil hole and the clearance between the outer face of the input shaft and the inner face of the hollow shaft portion and then reaches the through portion. When the vehicle travels in a state where the engine is stopped, oil spatters outward from the through portion in the radial direction of the hollow shaft portion by centrifugal force resulting from rotation of the sun gear. The spattered oil is trapped by the oil receiver and guided to the pinion gears. As a result, even when the vehicle travels in a state where the engine is stopped, it is possible to supply oil to the pinion gears for lubrication. In addition, because oil that has been spattered by centrifugal force is trapped by the oil receiver and guided to the pinion gears, it is possible to improve the efficiency of supplying oil to the pinion gears.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a cross-sectional view that shows part of a vehicle driving system according to the invention;

FIG. 2 is a cross-sectional view that shows part of another vehicle driving system according to the invention;

FIG. 3 is a cross-sectional view that shows part of further another vehicle driving system according to the invention;

FIG. 4 is a perspective view that shows part of a power split mechanism in the vehicle driving system shown in FIG. 3; and

FIG. 5 is a skeletal view that shows the overall configuration of the vehicle driving system according to the invention.

### DETAILED DESCRIPTION OF EMBODIMENTS

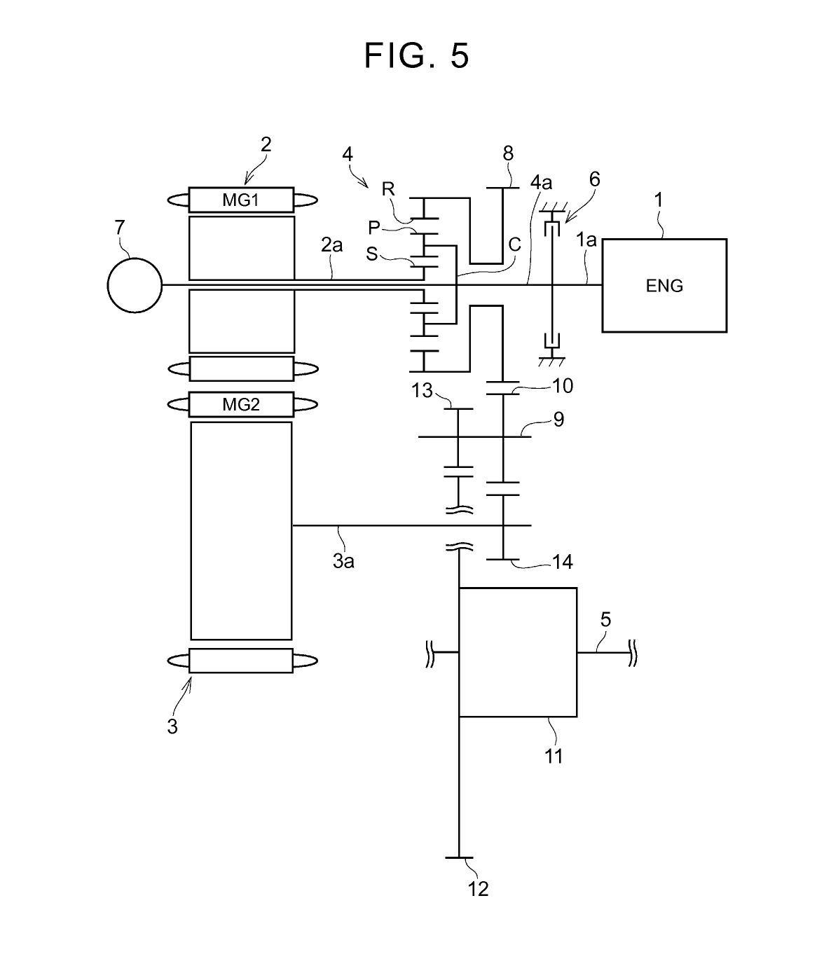

The invention will be specifically described. FIG. 5 is a skeletal view that shows the overall configuration of a vehicle driving system according to the invention. A hybrid vehicle shown in FIG. 5 includes an engine (ENG) 1, a first motor generator (MG1) 2 and a second motor generator (MG2) 3 as driving force sources. Power output from the engine 1 is transmitted while the power is distributed to the first motor generator 2 side and a drive shaft 5 side by a power split mechanism 4. Electric power generated by the first motor generator 2 is allowed to be supplied to the second motor generator 3, and torque output from the second motor generator 3 is allowed to be applied to the drive shaft 5.

The engine 1 is configured such that adjustment of the output, operation of startup or stop, and the like, are electrically controlled. For example, in the case of a gasoline engine, a throttle opening degree, a fuel supply amount, ignition and stop of ignition, ignition timing, and the like, are electrically controlled.

Each of the first motor generator 2 and the second motor generator 3 is a motor having a power generating function, and is, for example, formed of a permanent magnet synchronous motor, or the like. Each of the first motor generator 2 and the second motor generator 3 is connected to a battery (not shown) via an inverter (not shown). Each of the first motor generator 2 and the second motor generator 3 is configured such that a rotation speed, a torque, switching between the function of a motor and the function of a generator, and the like, are electrically controlled.

The power split mechanism 4 is formed of a differential mechanism having three rotating elements. In the example shown in FIG. 5, a single pinion planetary gear mechanism is used. The planetary gear mechanism that constitutes the power split mechanism 4 is arranged along the same axis as a crankshaft 1a of the engine 1. A rotor shaft 2a of the first motor generator 2 is coupled to a sun gear S that is an external gear. The first motor generator 2 is arranged next to the power split mechanism 4 across from the engine 1. A ring gear R that is an internal gear is arranged concentrically with the sun gear S. A plurality of pinion gears P are in mesh with these sun gear S and ring gear R. The plurality of pinion gears P are supported by a carrier C so as to be rotatable and revolvable. An input shaft 4a of the power split mechanism 4 is coupled to the carrier C. The crankshaft 1a of the engine 1 is coupled to the input shaft 4a. A brake mechanism 6 is provided between the engine 1 and the power split mechanism 4. The brake mechanism 6 is able to selectively stop rotation of the crankshaft 1a of the engine 1 or rotation of the input shaft 4a. A mechanical oil pump 7 is coupled to the input shaft 4a. When the input shaft 4a rotates, the mechanical oil pump 7 is driven.

An output gear 8 that is an output member is coupled to the ring gear R of the planetary gear mechanism. A counter shaft 9 is arranged parallel to the rotation axis of the power split mechanism 4, the first motor generator 2, or the like. A counter driven gear 10 is connected to one end of the counter shaft 9. The counter driven gear 10 is in mesh with the output gear 8. A counter drive gear 13 is connected to the other end of the counter shaft 9. The counter drive gear 13 is in mesh with a ring gear 12 of a differential gear 11. Thus, the ring gear R of the power split mechanism 4 is coupled to the drive shaft 5 via a gear train and the differential gear 11. The gear train is formed of the output gear 8, the counter shaft 9, the counter driven gear 10 and the counter drive gear 13.

Torque output from the second motor generator 3 is allowed to be added to torque that is transmitted from the power split mechanism 4 to the drive shaft 5. That is, the second motor generator 3 is arranged parallel to the counter shaft 9. A pinion gear 14 connected to a rotor shaft 3a of the second motor generator 3 is in mesh with the counter driven gear 10. The pinion gear 14 is formed of a gear having a smaller diameter than the counter driven gear 10. Therefore, the pinion gear 14 is configured to amplify torque output from the second motor generator 3 and transmit the amplified torque to the counter driven gear 10 and the counter shaft 9.

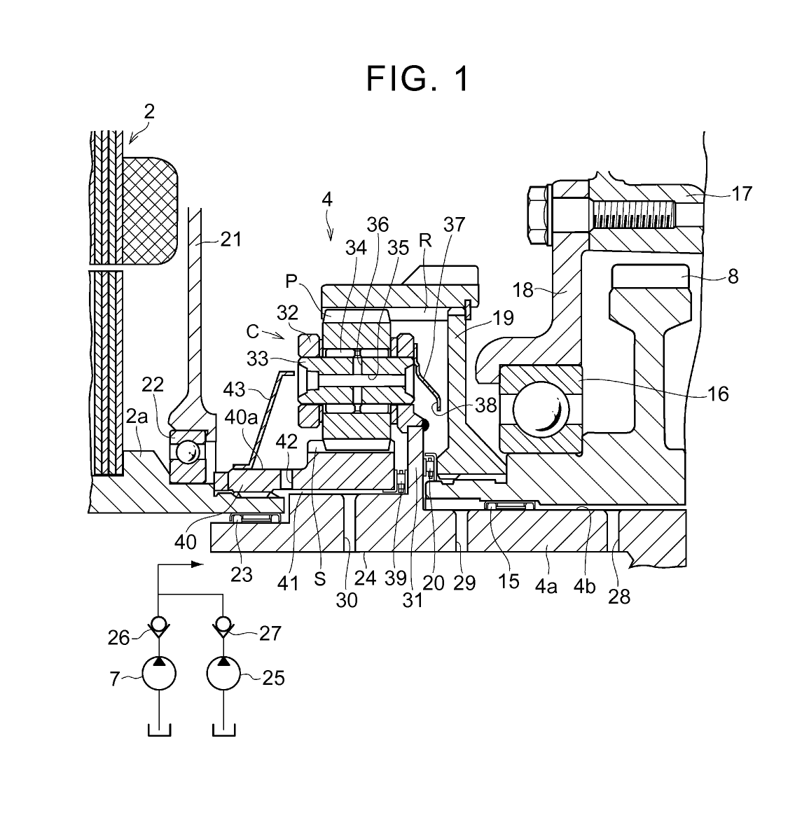

FIG. 1 is a cross-sectional view that shows part of the vehicle driving system according to the invention. As described above, the crankshaft 1a of the engine 1 is coupled to one end of the input shaft 4a of the power split mechanism 4. The output gear 8 is mounted at one end side on an outer face 4b of the input shaft 4a via a roller bearing 15. The output gear 8 is rotatably supported by a partition wall 18 via a bearing 16. The partition wall 18 is screwed to a casing 17. The outer face is the radially outer face of the shaft. For example, the outer face 4b is the radially outer face of the input shaft 4a. Similarly, the inner face is the radially inner face of the shaft. The ring gear R of the power split mechanism 4 is coupled to the output gear 8 via a coupling member 19. A thrust bearing 20 is arranged between the coupling member 19 and a flange (described later).

The other end of the input shaft 4a extends toward the first motor generator 2. The rotor shaft 2a of the first motor generator 2 is a hollow shaft. The rotor shaft 2a extends through a center support 21 integrally connected to the casing 17, and is supported by a bearing 22 so as to be rotatable with respect to the center support 21. The other end of the input shaft 4a is inserted inside the rotor shaft 2a. A roller bearing 23 is arranged between the inner face of the rotor shaft 2a and the outer face 4b of the input shaft 4a. The input shaft 4a is rotatably supported by the roller bearing 23.

A lubricating oil passage 24 is provided inside the input shaft 4a. The mechanical oil pump 7 communicates with the lubricating oil passage 24 via a check valve 26. An electric oil pump 25 communicates with the lubricating oil passage 24 via a check valve 27. The electric oil pump 25 is driven by a motor (not shown). The input shaft 4a has a plurality of oil holes that communicate with the lubricating oil passage 24 and that are open at the outer face 4b of the input shaft 4a. In the following description, those oil holes are referred to as a first oil hole 28, a second oil hole 29 and a third oil hole 30 in order from the engine 1 side.

As shown in FIG. 1, a flange 31 is integrally formed with the outer face 4b of the input shaft 4a, and the carrier C of the power split mechanism 4 is coupled to the flange 31. The carrier C includes two mutually facing side plate portions 32 and pinion shafts 33. Both ends of each of the pinion shafts 33 are respectively supported by the side plate portions 32. The pinion gears P are respectively mounted on those pinion shafts 33 so as to be rotatable. A pinion bearing 34 is provided between each pinion gear P and a corresponding one of the pinion shafts 33. Each pinion bearing 34 is used to smoothly rotate the corresponding pinion gear P. As shown in FIG. 1, each pinion shaft 33 has a through oil passage 35 and communication oil passages 36. The through oil passage 35 extends in a rotation center axis direction. The communication oil passages 36 communicate with the through oil passage 35 and are open at the outer face of the pinion shaft 33. These oil passages 35, 36 are used to supply oil to the corresponding pinion bearing 34. As will be described later, oil is introduced from both ends of the corresponding through oil passage 35.

An oil receiver 37 is attached to the engine 1-side side plate portion 32 of the carrier C. The oil receiver 37 traps oil that has been spattered from the thrust bearing 20 and guides the trapped oil to engine 1-side openings of the through oil passages 35 of the pinion shafts 33. As shown in FIG. 1, the outer peripheral portion of the oil receiver 37 is fixed to the engine 1-side side plate portion 32 of the carrier C at a portion radially outer side with respect to the pinion shafts 33. The inner peripheral portion of the oil receiver 37 extends toward the input shaft 4a so as to be spaced apart from the carrier C. That is, an opening 38 that is open toward the thrust bearing 20 is provided. The oil receiver 37 is an example of a second oil receiver according to the invention.

A thrust bearing 39 is arranged between the engine 1-side end face of the sun gear S and the flange 31. A cylindrical shaft portion 40 is integrally provided at the first motor generator 2 side of the sun gear S. The shaft portion 40 and the rotor shaft 2a of the first motor generator 2 are spline-fitted to each other. A clearance 41 is provided between both the inner face of the shaft portion 40 and the inner face of the sun gear S and the outer face 4b of the input shaft 4a. Of the plurality of oil holes 28, 29, 30, the third oil hole 30 provided at the first motor generator 2 side communicates with the clearance 41. The shaft portion 40 has a through portion 42. The clearance 41 and the outside of the shaft portion 40 communicate with each other via the through portion 42. Oil supplied from any one of the above-described oil pumps 7, 25 to the lubricating oil passage 24 of the input shaft 4a is supplied to the clearance 41 via the third oil hole 30. The oil flows through the clearance 41, and is spattered outward from the through portion 42 in the radial direction by centrifugal force resulting from rotation of the sun gear S. The above-described shaft portion 40 is an example of a hollow shaft portion according to the invention.

An oil receiver 43 is attached to an outer face 40a of the shaft portion 40. The oil receiver 43 traps oil that has been spattered from the through portion 42 and guides the trapped oil to first motor generator 2-side openings of the through oil passages 35 of the pinion shafts 33. In the example shown in FIG. 1, the oil receiver 43 has a hollow conical shape as a whole so as to cover the through portion 42. A small-diameter end of the oil receiver 43 is fixed to the outer face 40a of the shaft portion 40. A large-diameter end of the oil receiver 43 extends toward the through oil passages 35 of the pinion shafts 33. That is, the position of the large-diameter end in the radial direction of the input shaft 4a corresponds to the position of each through oil passage 35 in the radial direction. The oil receiver 43 is an example of a first oil receiver according to the invention.

In the above-described vehicle driving system, when torque for propelling the hybrid vehicle is output from the first motor generator 2, the input shaft 4a is fixed by the brake mechanism 6, and the output torque of the first motor generator 2 is increased by the differential action of the power split mechanism 4 and is transmitted to the output gear 8. Because the input shaft 4a is fixed as described above, the mechanical oil pump 7 is stopped. On the other hand, the electric oil pump 25 is driven, and oil is supplied from the electric oil pump 25 to the lubricating oil passage 24 of the input shaft 4a. Part of the oil is supplied to between the input shaft 4a and the output gear 8 via the first oil hole 28 and the second oil hole 29.

The other part of the oil is supplied to the clearance 41 via the third oil hole 30, flows along the clearance 41, and reaches the through portion 42. Because the sun gear S rotates together with the rotor shaft 2a of the first motor generator 2, oil that has reached the through portion 42 is spattered outward in the radial direction by centrifugal force resulting from rotation of the sun gear S. The spattered oil collides with the oil receiver 43. The oil moves outward in the radial direction of the oil receiver 43 along the shape of the oil receiver 43 by centrifugal force resulting from rotation of the oil receiver 43. Then, the oil is spattered from the pinion shaft 33-side large-diameter end of the oil receiver 43 toward the through oil passages 35 of the pinion shafts 33. In this way, the oil receiver 43 guides oil, which has been spattered from the sun gear S, to the through oil passages 35 of the pinion shafts 33.

Oil introduced into each of the through oil passages 35 flows along the corresponding through oil passage 35 and is supplied to the corresponding pinion bearing 34 via the corresponding communication oil passages 36. Oil that has reached each of the pinion bearings 34 lubricates the corresponding pinion gear P through the clearance between the pinion gear P and the carrier C. In this way, it is possible to lubricate the pinion shafts 33, the pinion bearings 34 and the pinion gears P.

When the engine 1 outputs torque for propelling the hybrid vehicle, the mechanical oil pump 7 is driven, and oil is supplied from the mechanical oil pump 7 to the lubricating oil passage 24. The brake mechanism 6 is released. Because the input shaft 4a is rotating, oil that has reached the oil holes 28, 29, 30 is spattered outward in the radial direction by centrifugal force resulting from rotation of the input shaft 4a. Part of oil that has been spattered from the second oil hole 29 to the clearance between the input shaft 4a and the output gear 8 passes through any gap in the thrust bearing 20 and is trapped by the oil receiver 37, and is guided again to the engine 1-side openings of the through oil passages 35. Oil introduced into each of the through oil passages 35 flows along the corresponding through oil passage 35 and is supplied to the corresponding pinion bearing 34 via the corresponding communication oil passages 36. Oil that has reached each of the pinion bearings 34 lubricates the corresponding pinion gear P through the clearance between the pinion gear P and the carrier C. In this way, it is possible to lubricate the pinion shafts 33, the pinion bearings 34 and the pinion gears P. The above-described second oil hole 29 is an example of another oil hole according to the invention. The above-described oil receiver 37 is an example of a second oil receiver according to the invention.

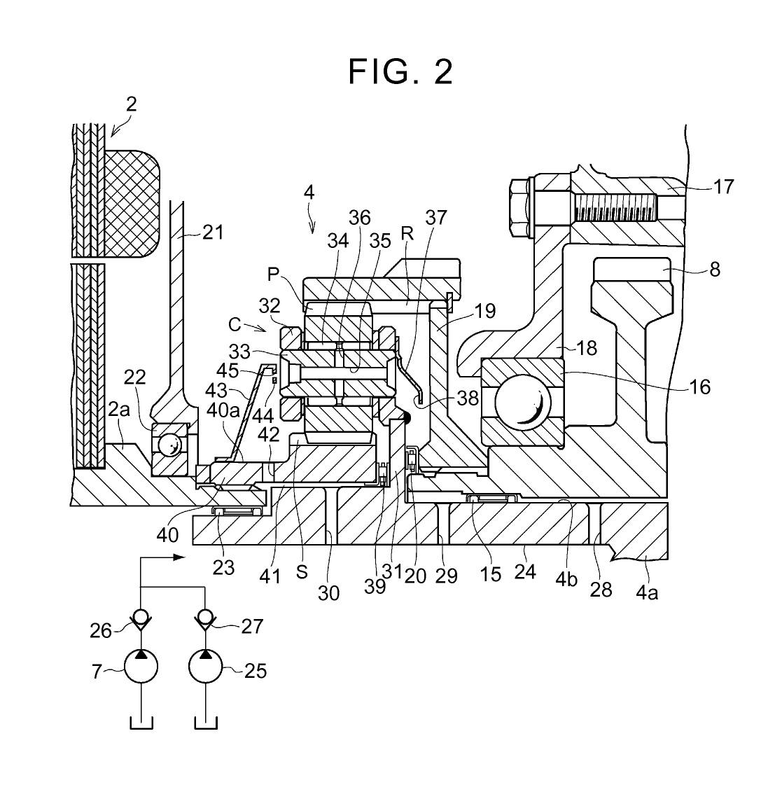

FIG. 2 is a cross-sectional view that shows part of another vehicle driving system according to the invention. A flat annular portion 44 is provided at the pinion shaft 33-side large-diameter end of the oil receiver 43. That is, the annular portion 44 extends inward from the large-diameter end in the radial direction of the input shaft 4a. Hole portions 45 are respectively provided in the annular portion 44 at positions corresponding to the through oil passages 35. For example, only a pair of the hole portions 45 are provided symmetrically with respect to the rotation central axis of the input shaft 4a. This is to, when oil is received by the oil receiver 43, smoothly rotate the shaft portion 40 and the sun gear S, that is, not to cause the center of gravity of the shaft portion 40 to deviate from the rotation central axis. Therefore, as long as it is possible to maintain smooth rotation of the shaft portion 40 and sun gear S, a plurality of the hole portions may be provided at constant intervals in the circumferential direction of the annular portion 44.

In the example shown in FIG. 2, as described above, when the first motor generator 2 outputs torque for propelling the hybrid vehicle, oil that has been spattered from the through portion 42 of the sun gear S and then collided with the oil receiver 43 once accumulates in the radially outer portion of the oil receiver 43. That is, the oil accumulates in an annular recessed portion defined by the large-diameter portion of the oil receiver 43 and the annular portion 44. The accumulated oil is blown off from the hole portions 45 toward the through oil passages 35 by centrifugal force hydraulic pressure generated as a result of rotation of the oil receiver 43. As a result, in the example shown in FIG. 2 as well, when the input shaft 4a is fixed and the first motor generator is outputting torque for propelling the hybrid vehicle, oil that has been spattered from the sun gear S is supplied to the through oil passages 35 respectively provided in the pinion shafts 33, so similar advantageous effects to those in the example shown in FIG. 1 are obtained. In the example shown in FIG. 2, because oil is blown off and supplied from the hole portions 45 toward the through oil passages 35 as described above, it is possible to improve the efficiency of supplying oil to the pinion shafts 33 as compared to the example shown in FIG. 1.

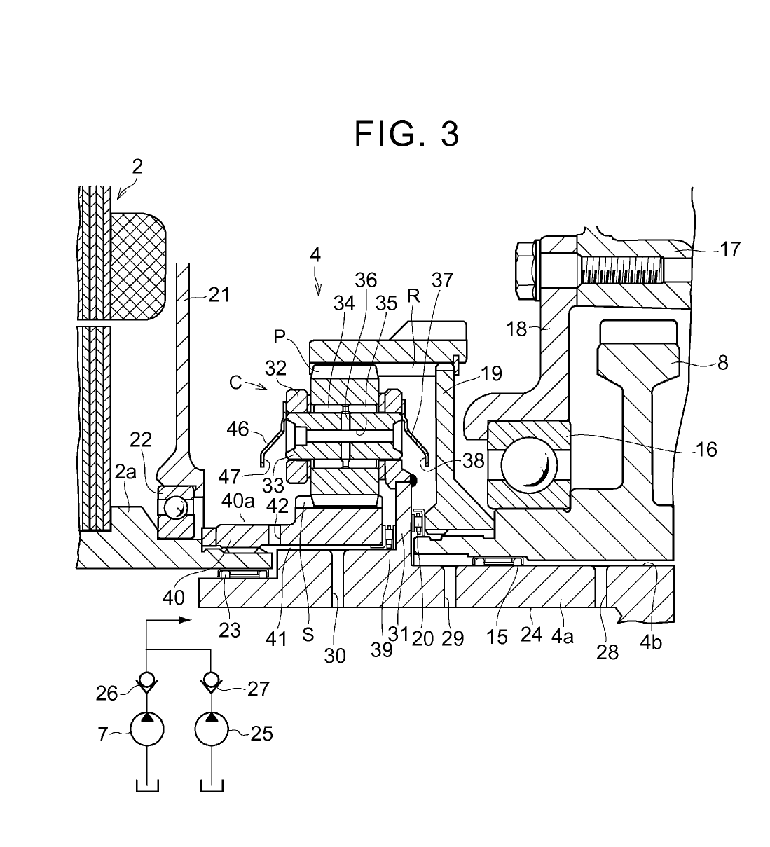

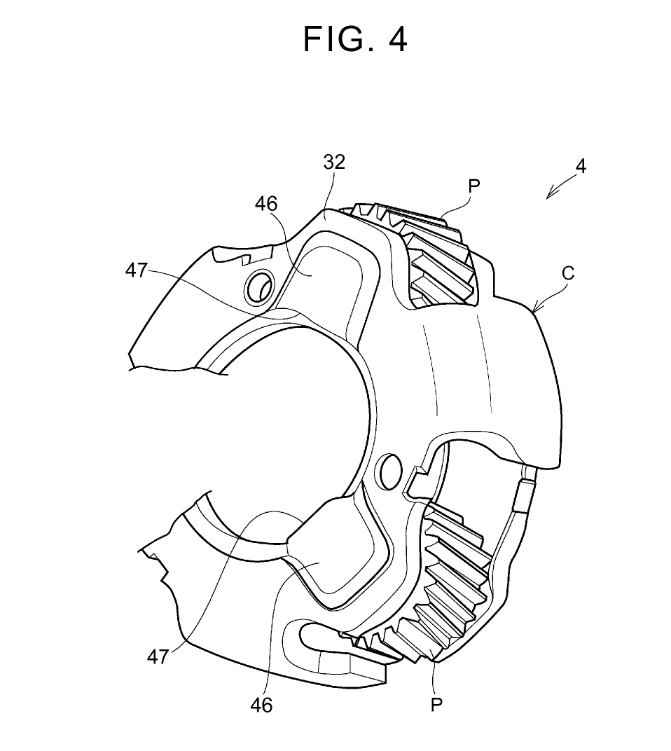

FIG. 3 is a cross-sectional view that shows part of further another vehicle driving system according to the invention. FIG. 4 shows a perspective view that shows part of a power split mechanism in the vehicle driving system shown in FIG. 3. As shown in FIG. 4, covers are attached to the first motor generator 2-side side plate portion 32 of the carrier C respectively at positions corresponding to the pinion gears P. Each of the covers bulges toward the first motor generator 2 and has an opening that is open toward the input shaft 4a. The radially outer portion of each of those covers is fixed to a radially outer side with respect to the corresponding pinion shaft 33 in the side plate portion 32. Each of those covers serves as an oil receiver 46. The opening 47 of each oil receiver 46 is provided at a position corresponding to a corresponding one of the through portions 42 in the radial direction of the input shaft 4a. Therefore, oil that has been spattered from the through portions 42 is trapped by the oil receivers 46. The trapped oil moves along the shape of each oil receiver 46, that is, the trapped oil is guided to the through oil passage 35 of each pinion shaft 33.

Therefore, in the example shown in FIG. 3 and FIG. 4 as well, when the input shaft 4a is fixed and the first motor generator is outputting torque for propelling the hybrid vehicle, it is possible to collect oil, which has been spattered from the sun gear S, with the oil receivers 46 and to guide the oil to the through oil passage 35 of each pinion shaft 33. Therefore, similar advantageous effects to those in the example shown in FIG. 1 and FIG. 2 are obtained.

What is claimed is:

1. A driving system for a vehicle, the driving system comprising:
an engine;
a motor;
an output member; and
a power split mechanism configured to distribute power, output from the engine, to the motor and the output member, the power split mechanism including:
a sun gear that is an external gear;
a ring gear that is an internal gear, the ring gear being arranged concentrically with the sun gear, the motor being coupled to one of the sun gear and the ring gear, the output member being coupled to the other one of the sun gear and the ring gear;
a carrier that supports a plurality of pinion gears so as to be rotatable and revolvable, the plurality of pinion gears being in mesh with the sun gear and the ring gear;
an input shaft that couples the carrier to the engine, the input shaft having a lubricating oil passage and a first oil hole, the first oil hole communicating the lubricating oil passage with an outer face of the input shaft;
a hollow shaft portion that rotates integrally with the sun gear and the hollow shaft portion is fitted to a radially outer side of the input shaft so as to be relatively rotatable, the hollow shaft portion having a through portion, the through portion extending through from an inner face of the hollow shaft portion to an outer face of the hollow shaft portion; and
a first oil receiver that is arranged on an outer side of the through portion in a radial direction of the hollow shaft portion, the first oil receiver being configured to trap oil spattered outward from the through portion in the radial direction of the hollow shaft portion and guide trapped oil to the pinion gears.

2. The driving system according to claim 1, wherein
the first oil receiver has a hollow conical shape,
a first end of the first oil receiver is fixed to the outer face of the hollow shaft portion, and a second end of the first oil receiver extends toward the pinion gears, and
a diameter of the first end is smaller than a diameter of the second end.

3. The driving system according to claim 1, wherein
the first oil receiver is provided at each of positions corresponding to the plurality of pinion gears, and
each first oil receiver has an opening that is open toward the through portion.

4. The driving system according to claim 2, wherein
the first oil receiver includes an annular portion extending inward from the second end in the radial direction of the hollow shaft portion, and
the annular portion has hole portions extending through the annular portion at positions corresponding to the pinion gears.

5. The driving system according to claim 1, wherein
the motor is coupled to the sun gear, and the output member is coupled to the ring gear.

6. The driving system according to claim 1, further comprising a brake mechanism configured to stop rotation of the carrier.

7. The driving system according to claim 1, further comprising a second oil receiver, wherein
the input shaft has a second oil hole,
the second oil hole communicates the lubricating oil passage with the outer face of the input shaft, and an axial position of the second oil hole is different from an axial position of the sun gear or an axial position of the hollow shaft portion, and
the second oil receiver is configured to trap oil spattered outward from the second oil hole in the radial direction of the input shaft and guide trapped oil to the pinion gears.
